(19) United States
(12) Patent Application Publication
(10) Pub. No.: US 2021/0237887 A1
(43) Pub. Date: Aug. 5, 2021

(54) PROPULSION SYSTEM FOR A HELICOPTER

(71) Applicant: SAFRAN HELICOPTER ENGINES, BORDES (FR)

(72) Inventors: Jean-Louis Robert Guy Besse, Moissy-Cramayel (FR); Benjamin Antoine Boussand, Moissy-Cramayel (FR)

(73) Assignee: SAFRAN HELICOPTER ENGINES, BORDES (FR)

(21) Appl. No.: 17/052,371

(22) PCT Filed: Apr. 25, 2019
(86) PCT No.: PCT/FR2019/050978

§ 371 Date: Nov. 2, 2020

(30) Foreign Application Priority Data
May 3, 2018 (FR) 1853806

(51) Int. Cl. B64D 27/24; B64C 27/12

(52) U.S. Cl. CPC B64D 27/24; B64D 35/08; B64C 27/12

(57) ABSTRACT

A propulsion system for a helicopter includes a linked turbine engine that is configured to drive a main rotor configured to be coupled to a rotary wing. The propulsion system further includes an electric machine that is configured to form an electric motor. The electric machine is coupled directly or indirectly to the main rotor.

### FIELD OF THE INVENTION

The present invention relates to a propulsion system for a helicopter.

### BACKGROUND OF THE INVENTION

A helicopter is typically equipped with a main rotor driving a rotating wing to provide lift and propulsion. It is also known to equip a helicopter with a small or tail rotor, also known as an anti-torque rotor (ATR), to counteract the torque exerted by the main rotor on the helicopter fuselage.

In order to rotate the main rotor and, where applicable, the anti-torque rotor, the helicopter is equipped with a propulsion system that includes a turboshaft engine. The turboshaft engine may comprise a so-called free turbine or a so-called linked turbine.

In the case of a free turbine engine, a first turbine, so-called high pressure, drives the engine's compressor, while a second turbine, so-called low pressure, is connected to a reduction gearbox, also called main gearbox or MGB. The latter allows the speed to be reduced before transmitting the torque to the helicopter's main rotor. Free-turbine engines are known as “double-shaft” engines.

In the case of a turboshaft engine with a linked turbine, all the compressor or turbine stages are attached to a single shaft. These motors are known as “single shaft” motors. The entire engine assembly is directly connected by this single axle to the main gearbox.

A free turbine engine, although having a more complex structure, allows it to operate close to optimum efficiency over a wide range of operating speeds.

Conversely, a turboshaft engine with a linked turbine has a less complex structure but only has an optimum operating point. Operating the engine at speeds other than this optimum operating point causes a significant drop in efficiency. There is also a high risk of pumping, especially in high transient regimes.

Because of these various constraints, the turboshaft engines currently in use are free turbine engines. As indicated above, such turboshaft engines have a complex architecture, require a large number of parts and are less reliable than turboshaft engines with linked turbines, and have a higher mass and higher manufacturing and maintenance cost.

There is therefore a need to compensate for the different disadvantages of the two architectures.

### SUMMARY OF THE INVENTION

For this purpose, the present invention concerns a propulsion system for a helicopter, comprising a turboshaft engine with a linked turbine able to drive a main rotor intended to be coupled to a rotating wing, characterised in that the propulsion system comprises an electric machine, able to form an electric motor, said electric machine being coupled, directly or indirectly, to the main rotor.

In this way, it is possible to operate the turboprop so as to provide maximum continuous power close to an optimum operating point of the turboshaft engine and to operate the electric machine as an electric motor, so as to deliver additional power to the main rotor, in a transient operating phase, such as a take-off or landing phase.

It should be noted that the electric motor can also be used to drive the main rotor in the event of a failure or malfunction of the turboshaft engine.

It should be noted that, in a turboshaft engine with a linked turbine, all the compressor or turbine stages are attached to a single shaft, forming the output shaft of the turboshaft engine.

The electric machine may also be suitable for forming an electric generator.

Alternatively, the functions of electric motor and electric generator can be performed by two separate components.

The propulsion system may comprise a main gearbox, a first driveshaft connecting the main gearbox to the main rotor, a second driveshaft connecting the turbo engine to the main gearbox, the main rotor being rotatable by the turbo engine through the main gearbox and the first and second driveshafts.

The first driveshaft can be oriented perpendicular to the first and second driveshafts.

The main gearbox may have gears forming one or more reduction stages. Gears include, for example, bevel gears forming at least one bell crank.

The propulsion system may comprise an anti-torque rotor, a third driveshaft connecting the main gearbox and the anti-torque rotor, said anti-torque rotor being capable of being rotated by the turbo engine through the main gearbox and the first and third driveshafts.

The electric machine can have a rotor coupled to the second driveshaft.

The electric machine can have a rotor coupled to the third driveshaft.

The propulsion system may include a freewheel mounted between the turboshaft and the second driveshaft.

The freewheel enables the turbo engine and the second transmission shaft to be coupled in rotation in a first direction of rotation of said elements, and to decouple these elements in rotation in a second, opposite direction of rotation.

When the rotor of the electric machine is coupled to the second driveshaft and the freewheel is mounted between the turbo engine and the second driveshaft, then the electric machine operating as an electric motor can be used to start the turbo engine. It should be noted, however, that if the turboshaft engine and the linked turbine jam, the electric motor cannot deliver its power to the main gearbox, for a safety manoeuvre for example.

The propulsion system may include a freewheel mounted between the main gearbox and the second driveshaft.

The freewheel enables the second transmission shaft and the main gearbox to be coupled in rotation in a first direction of rotation of said elements, and to decouple these elements in rotation in a second, opposite direction of rotation.

When the rotor of the electric machine is coupled to the second driveshaft and the freewheel is mounted between the main gearbox and the second driveshaft, then the electric machine operating as an electric motor can be used to drive the main rotor and/or the anti-torque rotor, even if the turboshaft engine and the linked turbine jam, in order to facilitate a safety manoeuvre for example. It should be noted, however, that in such a configuration, the electric machine cannot be used to start the turbo engine.

The electric machine can be combined with an electric accumulator, such as a battery or a supercapacitor.

The electric machine is thus suitable for being powered by the electric accumulator when the electric machine is operating as an electric motor. The electric machine is also suitable for recharging the electric accumulator when the electric machine is operating as an electric generator.

The invention also relates to a helicopter comprising a propulsion system of the aforementioned type.

The invention also relates to an operating method for a propulsion system characterised in that it includes the following steps:
operating the turboshaft engine with a linked turbine so as to provide maximum continuous power near a point of optimal operation of said turboshaft engine;
operating the electric machine as an electric motor so as to deliver additional power to the main rotor and/or the anti-torque rotor, in a transient operating phase, such as a take-off or landing phase;
operating the electrical machine as an electrical generator to recharge the accumulator in a phase that does not require additional power to be supplied to the main rotor or the anti-torque rotor.

In this way, during a take-off phase, the electric machine can operate in addition to the turboshaft engine with a linked turbine so as to provide additional power and deliver to the main rotor and/or the anti-torque rotor a total power greater than the maximum continuous power, which is substantially the power that can be delivered by the turboshaft engine. This prevents the turbo engine from being operated outside its optimum operating point, thus ensuring high efficiency of the turbo engine.

Such a mode of operation is also applicable during a landing phase, as such a phase also requires more power at the rotors.

Finally, such an operation can be applied to any transient phase in flight, requiring a temporary increase in power.

In the stabilised or cruising flight phase, the electric machine can operate as a generator so as to recharge the accumulator, a small part of the power generated by the turboshaft engine being used for this purpose so as to counteract in particular the electromagnetic torque caused by operation in generator mode.

The invention will be better understood and other details, characteristics and advantages of the invention will appear when reading the following description, which is given as a non-limiting example, with reference to the attached drawings.

### BRIEF DESCRIPTION OF THE FIGURES

FIG. 1 is a schematic view of a helicopter provided with a propulsion system according to a first embodiment of the invention;

FIG. 2 is a schematic view of a helicopter provided with a propulsion system according to a second embodiment of the invention;

FIG. 3 is a schematic view of a helicopter provided with a propulsion system according to a third embodiment of the invention;

FIG. 4 is a diagram representing, in particular, the power supplied by the turboshaft engine and the electric motor during the various phases of flight of the helicopter.

### DETAILED DESCRIPTION

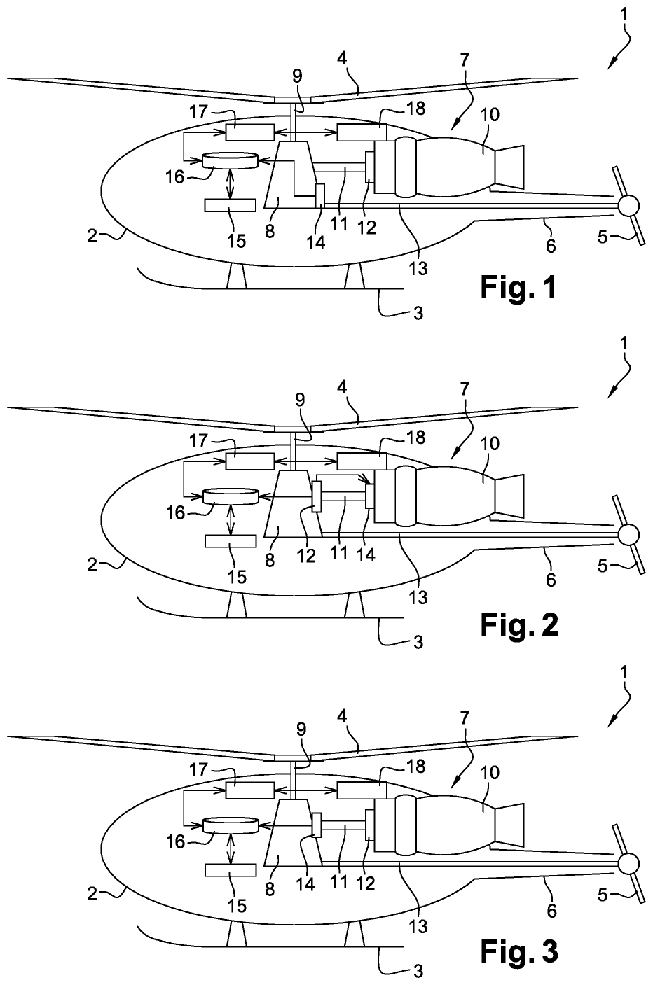

FIG. 1 represents a helicopter 1 in a first embodiment of the invention, having an airframe comprising a fuselage 2 and a landing gear 3, a main rotor 4 associated with a rotating wing, forming a single lift rotor and an anti-torque rotor 5 located at the end of a beam 6 at the rear of fuselage 2. Rotors 4, 5 are driven by a propulsion system or group 7.

Propulsion system 7 comprises a main gearbox 8 or MGB. The main gearbox 8 usually has gears forming one or more reduction stages. A first driveshaft 9 connects the main gearbox 8 to the main rotor 4.

The propulsion system further comprises a turboshaft engine 10 with linked turbine, in which all the compressor or turbine stages are attached to a single shaft forming an output shaft.

The output shaft of the turbo engine 10 is connected to a second driveshaft 11 via a freewheel 12. The freewheel 12 enables the output shaft of the turbo engine 10 and the second driveshaft 11 to be coupled in rotation in a first direction of rotation, and to decouple in rotation the above-mentioned shafts in a second opposite direction of rotation.

The second driveshaft 11 is coupled to the main gearbox 8.

A third driveshaft 13 allows to couple the main gearbox 8 to the anti-torque rotor 5.

The propulsion system 7 furthermore comprises an electric machine 14, capable of forming an electric motor, said electric machine 14 being coupled, directly or indirectly, to the third driveshaft 13.

The electric machine 14 is connected to an electric accumulator 15, e.g. a battery or a supercapacitor, which supplies power to the electric machine 14 when it is accumulator 15 can be recharged by the electric machine 14 when it is operating as an electric generator.

The propulsion system 7 and/or the helicopter 1 also comprise control and/or power electronics 16, means of regulation 17 of the FADEC (Full Authority Digital Engine Control) type, and means 18 for controlling the fuel flow and controlling the geometry of an inlet grid of the compressor of the turbo-shaft engine 10, these various elements being connected to each other, to the electric machine 14, to the accumulator 15 and/or to the turbo-shaft engine 10 so as to ensure the control and monitoring of the various elements.

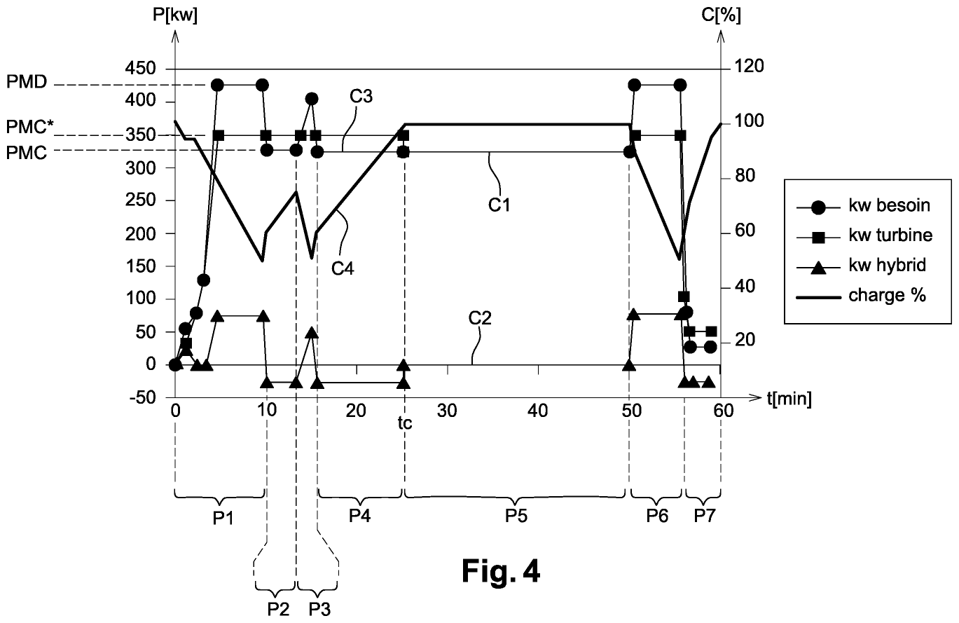

The operation of such a propulsion system 7 will now be explained with reference to the diagram in FIG. 4.

This diaphragm has four curves referenced respectively C1, C2, C3, C4. The diagram shows the time t in minutes on the x-axis. In addition, the diagram shows the power P in kW on the y-axis and the battery charge C 15 in percent.

The C1 curve represents the evolution of the power delivered by the turbo engine 10 as a function of time. The C2 curve represents the evolution of the power delivered by the electric machine 14 as a function of time. Curve C3 is the total power supplied to rotors 4, 5 as a function of time, i.e. the sum of curve C1 and curve C2.

Curve C4 represents the evolution of the state of charge of accumulator 15 as a function of time.

The diagram in FIG. 4 represents a phase of flight consisting of a take-off phase, a phase of abrupt change in power demand, a stabilized or cruise phase, and a landing phase.

As can be seen in the diagram, in take-off phase P1, the power of turboshaft engine 10 is brought to a power rating PMC*, which corresponds to an increased maximum continuous power of turboshaft engine 10. This is the maximum power that can be delivered by the turboshaft engine 10. During the take-off phase, the power requirements are higher than the PMC* power. The electric motor is activated or driven to provide additional power and bring the total power to a setpoint noted PMD. It will be noted that electric motor 14 can also be activated or actuated at the beginning of the take-off phase in order to start turboshaft engine 10.

During the take-off phase, the charge of the accumulator 15 gradually decreases due to the starting of the electric motor 14.

At the end of the take-off phase, the flight phase comprises a first stabilised flight phase P2 during which the electric motor 14 can be stopped, the electric machine 14 then operating in electric generator mode, so as to progressively recharge the accumulator 15.

In the event of a manoeuvre requiring an increase in the power to be supplied to rotors 4, 5 (flight phase referenced P3), the total power to be supplied is again greater than PMC*, again requiring the electric motor 14 to be started in order to bring the total power to the desired value. During this phase, the charge of the accumulator 15 is gradually reduced.

At the end of such a manoeuvre, the flight is stabilized again (flight phase referenced P4). During this second phase of stabilized flight, the electric motor 14 is shut down, with the electric machine 14 operating again in electric generator mode to recharge the accumulator 15. The accumulator 15 is fully charged at the time tc is shown in the diagram.

Above tc, the accumulator 15 is no longer charged using the electric generator 14, which reduces the electromagnetic resistive torque induced by generator 14. The power to be delivered by the turboshaft engine 10 is then reduced to a PMC value, corresponding to a not increased maximum continuous power of the turboshaft engine 10 (phase P5).

At the end of the flight, a landing manoeuvre is carried out (phase referenced P6), such a manoeuvre again requiring an increase in the total power to be supplied to rotors 4, 5, above the PMC* value. The power of turboshaft engine 10 is increased to PMC* and the electric motor 14 is activated or driven so that the total power to be delivered corresponds to the PMD value. During this phase P6, the accumulator 15 is gradually discharged.

At the end of the landing stage, the electric motor 14 is stopped, and the operation of the turboshaft engine 10 can be maintained so as to provide sufficient reduced power to drive the electric machine 14 in generator mode so as to recharge the accumulator 15 until it reaches full charge (phase P7).

Of course, the recharging phase of the accumulator 15 on the ground can be carried out by other means, as is known per se.

In the first embodiment, the electric motor 14 can also drive rotors 4, 5 in the event of failure or breakdown of the turboshaft engine 10, in order to carry out an emergency landing manoeuvre for example.

FIG. 2 illustrates a second embodiment of the invention which differs from that described above in that the freewheel 12 is located between the main gearbox 8 and the second driveshaft 11. The second driveshaft 11 can then form the output shaft of the turbo engine 10. Furthermore, in this second embodiment, the electric machine is coupled, directly or indirectly, to the second driveshaft 11.

In this second embodiment, the electric machine 14 operating as an electric motor can be used to start the turbo engine 10. However, if the linked turbine jams, the electric motor 14 will not be able to deliver its power to the main gearbox 8. It may possibly be useful to provide means of disengagement between the turbo engine 10 and the second driveshaft 11 in order to avoid such a disadvantage.

FIG. 3 illustrates a third embodiment which differs from the one described above with reference to FIG. 2 in that the freewheel 12 is located between the output shaft of the turbo engine 10 and the second driveshaft 11, and in that the electric machine 14 is coupled, directly or indirectly, to the second driveshaft 11.

In this third embodiment, the electric machine 14 operating as an electric motor can not be used to start the turbo engine 10. However, if the linked turbine jams, the electric motor 14 will be able to deliver its power to the main gearbox 8.

1. A propulsion system for a helicopter, comprising a turboshaft engine with a linked turbine able to drive a main rotor configured to be coupled to a rotating wing, the propulsion system comprising an electric machine configured to form an electric motor, said electric machine being coupled to the main rotor, the electric machine comprising a rotor coupled to one of a second transmission shaft and a third transmission shaft.

2. The propulsion system according to claim 1, wherein the electric machine is further configured to form an electric generator.

3. The propulsion system according to claim 1, further comprising a main gearbox, wherein a first driveshaft connects the main gearbox to the main rotor, the second driveshaft connects the turbo engine to the main gearbox, and the main rotor is configured to be rotated by the turbo engine through the main gearbox and the first and second driveshafts.

4. The propulsion system according to claim 3, further comprising an anti-torque rotor, the third driveshaft connecting the main gearbox and the anti-torque rotor, said anti-torque rotor being configured to be rotated by the turbo engine through the main gearbox and the first and third driveshafts.

5. The propulsion system according to claim 3, further comprising a free wheel mounted between the turboshaft engine and the second transmission shaft.

6. The propulsion system according to claim 3, further comprising a free wheel mounted between the main gearbox and the second transmission shaft.

7. The propulsion system according to claim 1, wherein the electric machine is associated with an electric accumulator.

8. A method for operating a propulsion system according to claim 1, the method comprising the steps of:
operating the turboshaft engine with a linked turbine to provide maximum continuous power near a point of optimal operation of said turboshaft engine;
operating the electric machine as an electric motor to deliver additional power to the main rotor and/or the anti-torque rotor, in a transient operating phase, such as a take-off or landing phase;
operating the electrical machine as an electrical generator to recharge the accumulator in a phase that does not require additional power to be supplied to the main rotor or the anti-torque rotor.

9. The propulsion system of claim 7, wherein the electric accumulator includes at least one of a battery and a supercapacitor.
